(19) United States
(12) Patent Application Publication
(10) Pub. No.: US 2002/0167442 A1
(43) Pub. Date: Nov. 14, 2002

(54) GPS explorer

(76) Inventor: William Michael Frederick Taylor, Newenden (GB)

Correspondence Address: LAHIVE & COCKFIELD, 28 STATE STREET, BOSTON, MA, 02109, US

(21) Appl. No.: 09/878,040

(22) Filed: Jun. 7, 2001

Related U.S. Application Data
(63) Continuation of application No. 09/653,042, filed on Sep. 1, 2000, now abandoned.
Application No. 09/653,042 is a continuation of application No. 09/132,433, filed on Aug. 11, 1998, now abandoned.
Application No. 09/132,433 is a continuation of application No. 08/553,383, filed on Nov. 14, 1995, now abandoned.

(30) Foreign Application Priority Data
May 18, 1993 (GB) 9310175.6
May 18, 1994 (US) PCT/GB94/01067

(51) Int. Cl. G01S 5/14

(52) U.S. Cl. 342/357.09; 342/357.1

(57) ABSTRACT

This is a portable information system which uses Global Positioning System (GPS) data as a key to automatically retrieve audiovisual data from a database. On a journey the system can automatically identify and describe places of specific interest to the user, landmarks and the history of nearby buildings, or locate hotels, hospitals, shops and products within a radius of the present position. Audible menus and voice command give hands-free and eyes-free control while driving, flying, sailing or walking.

### TECHNICAL FIELD

The invention is a portable information system which uses Global Positioning System (GPS) data as a key to retrieve audio visual information from a database or broadcast.

### BACKGROUND TO THE INVENTION

Almost everyone who travels needs information about the place they are visiting. However, we all have different needs and interests, some need commercial information, others may wish to buy a product, some people like to know the history of a place, or to discover hidden corners, others are simply bored and long for their journey to be made more interesting.

As databases grow in size so the problem of finding relevant data when it is needed becomes more difficult to solve. Few people have the time, motivation or patience to search through telephone books, yellow pages, guide books, information systems and the like. Having taken a long trip it is often only on returning home when one learns too late what has been missed. Even when at home it can be difficult to find out what is happening in the area today which might be of interest.

When walking, driving, sailing or flying our need for information remains, although our ability to search for it may be severely limited by the task in hand. We frequently need to switch modes of travel between car/aircraft/boat/bus/horseback or foot.

Most portable GPS receivers on the market today are designed for navigation, giving the user's position in terms of latitude and longitude or bearing and distance from a known point, both methods are cumbersome to use. Although GPS moving map displays show positions more clearly, their applications remain rather limited, due to the need for a screen and the risk of distraction when walking or driving. Both types of GPS system offer the user little other information.

Talking books using CD-ROM disks may provide the information lacking in the above mentioned navigation systems, however as the location of the user is not monitored automatically, any information must be extracted manually by the user, which can be laborious.

Portable computers and pen computing systems provide essentially text based information on the move. However, neither offer user friendly, hands-free, eyes-free operation with automatic, dynamically retrieved audio (and video) data based on the users position, altitude, attitude, speed, time, direction of view, stated needs and interests. It is not easy to use such a portable PC when walking or riding on horseback.

### THE INVENTION

GPS EXPLORER is a portable information system using Global Positioning System (GPS) data as a key to retrieve audio and video from a database or from broadcast data. The user may preselect the type of data of interest to him, then as his position, direction, speed, altitude or attitude change and the time of day changes, this is detected by the GPS receiver and the system automatically retrieves the appropriate data from the database. The device incorporates an internal exchangeable database on compact disk and can also access external databases and broadcast data.

GPS Explorer is designed to provide information on the move. In most of the applications envisaged the user has little need to know his location, simply wishing to be told about places of interest to him such as the history of a nearby building or where to buy a product. The fact that the information the user requires comes from a device which uses GPS position, speed, altitude or time as a key to access a database need not concern the user or be apparent.

To enable the user to operate the system hands-free and eyes-free while driving, flying, sailing, riding or walking, it may be controlled using audible menus and voice command. Telephone calls may also be made automatically via an integrated cellphone or satellite phone using numbers retrieved from the database.

On a journey the system can for example be set to automatically identify places of likely interest to the user, to describe the history of nearby buildings or the prettiest route to take. The user can also initiate an automatic search of the database for specific things of interest to him, such as landmarks, hotels, hospitals, shops or products, usually, though not necessarily, within a radius of his present position.

The basic device is a portable audio information system which uses GPS data as a key or keys to retrieve digital audio from a database contained within the device or attached to it by any means or received by any means including telephone, radio or television broadcast.

When equipped with or attached to a screen, the device may also include the facility to retrieve still and motion video sequences from a database contained within or attached to the device by any means or received by any means including telephone, radio or television broadcast. When connected to a display, the system may also be used to preview trips.

The system can provide GPS positioned simulations using virtual reality displays. The GPS derived position, elevation, viewing direction and time of day, enables simulated structures, buildings, dams, roads and landscape features to be dropped into the users field of view and to be examined from all angles around the proposed site while it is still virgin territory.

The device constantly monitors it's position, speed, direction of movement, the time and any like data by reference to a GPS receiver either incorporated within the device or connected to it by any means. Whenever the device detects a change in any GPS parameters, such as a change in location or time, it will use the new GPS data as a key or keys to search the database including received broadcast data and retrieve any data records which directly or indirectly match or relate to the new GPS parameters. Before being output as audio or displayed, the retrieved data will be checked against the mode of operation of the device and against other selection criteria, to determine which, if any, of the retrieved data items are to be presented to the user. A rolling log of messages will be kept to avoid needless repetition.

The device may be controlled by voice command or by keyboard, switch or joystick, directly or remotely. The user may select the mode of operation of the device, data retrieval criteria and other operating criteria.

The device has an audible menu system which when used with voice command, enables the device to be used hands free and eyes free. Feedback protection avoids the audio output triggering the voice input system.

The device may be fitted with a telephone interface enabling telephone calls to be placed to numbers retrieved from the database or broadcast data. The device may also be fitted with an interface for the attachment of optical, magnetic, radio or other devices capable of inputting data for the purpose of identifying location, products, persons, vehicles, systems, temperatures or any environmental variables.

The device determines user orientation, direction of movement, speed, pitch and role, altitude, rate of climb or descent, and the user's direction of view in terms of bearing, angle of azimuth and range. The system can also accept optical or other inputs to identify locations within buildings, which would otherwise be out of GPS reception.

### DESCRIPTION OF PREFERRED EMBODIMENTS

1. An audio only version of the design will now be described by reference to the accompanying drawings.

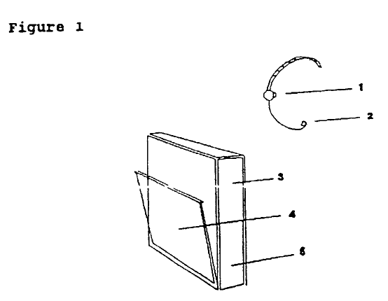

FIG. 1 shows the audio only version of the device comprising: audio earpiece 1, microphone 2, the GPS receiver 3, the CD drive 4 and the processor 5.

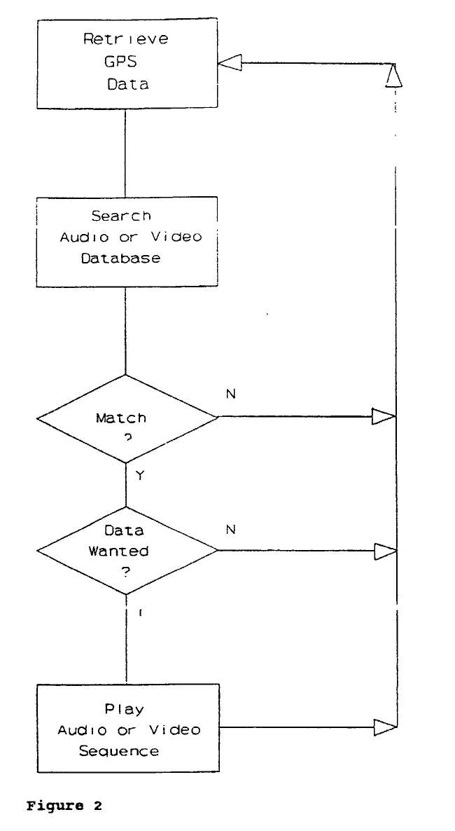

FIG. 2 shows the basic logic used to monitor the user's position and to retrieve and play the appropriate audio.

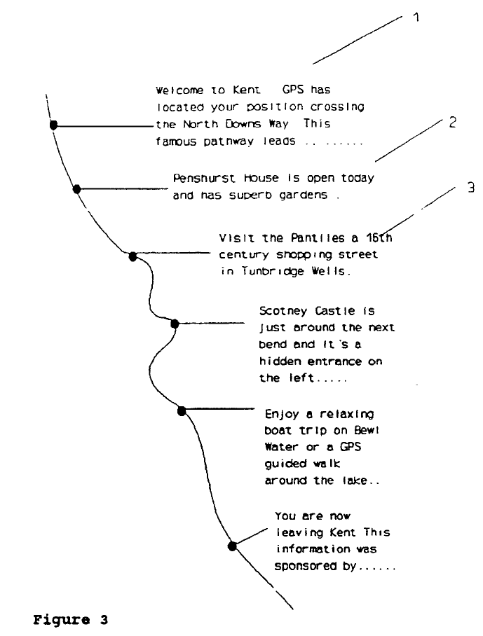

FIG. 3 shows a map on which large dots represent the positions determined by GPS at which specific audio phrases will be selected from the database or radio broadcast and played. Samples of typical audio phrases are numbered 1-6.

The GPS latitude/longitude co-ordinates of places of interest such as historic buildings, castles, villages, parks, lakes, mountains, panoramic viewpoints and so forth may be digitized from maps or by on site survey. Audio describing each place or interest will then be recorded and stored, in compressed form, with corresponding GPS coordinates, in a database on a compact disc (GPS-CD).

The portable GPS Explorer may then be used with such a GPS-CD database to provide information to the user who may select one or more of the device's many modes of operation, such as for example:

En Route Mode:

FIG. 3 shows a typical journey by car along a major road. By constantly monitoring GPS data, the device will determine when each of the locations 1-6 has been reached, the corresponding audio phrase will then be retrieved from the GPS-CD database or broadcast data and played to the user through an earpiece or loudspeaker.

There may be several locations at which broadly similar messages would be applicable, such as approaching a village from the North, South, East or West. In this case, the appropriate audio messages may be assembled from several phrases with variables such as left and right inserted as determined by user orientation, thus enabling more economic use to be made of available database space.

Tour Mode.

The user may select a tour either from the main menu or when offered the option en route. The system will then provide tour guidance and point out things of interest. For example when walking or driving past historic buildings or other features information about each building will be given. It's date of construction, who lived there, how it was built, if it is open to the public. The dialogue may include historic sounds, the crack of a coachman's whip, the voices of children at play, music drifting on the air, all creating the atmosphere of a bygone age.

Hazard Warning Mode.

If this mode has been selected it will take priority over other modes in use at the time such as tour mode. When approaching a hazard the system will interrupt any other audio message to alert the user. For example in road use a dangerous bend, a school or a steep hill. In flying mode to warn of controlled airspace.

Guidance Mode.

The GPS lat/long location of a road junction will be digitized and audio recorded for each direction of approach to each junction. The device will identify the users position and direction of travel on the approach to a junction by reference to GPS data and then retrieve the appropriate audio in advance of the junction to act as an audio signpost. The audio signpost will not be restricted to just place names as it may include much more information about road type, places of interest en route, warnings such as no fuel for 50 miles and so on.

Destination Oriented Guidance Mode.

When this mode is first selected the user will be prompted to choose a destination. A route from the present position to the destination will be determined from routing data. The device will then provide only the single direction needed at each junction to reach the destination without referring to unwanted directions.

What's on Mode.

The device will examine the co-ordinates of all the specially identified places of interest in the immediate area, gradually working out from the present GPS location. The device will then play a short audio phrase for each activity to briefly arouse the interest of the user. The user may then select any activity and obtain further details for deliberation, after which GPS guidance will be provided to the venue on request. An auto dial telephone number may be added for use via the telephone interface, to enable reservations to be made for hotels, theatres or similar venues without the need to write down then dial the number.

Walking Mode v Driving Mode v Flying Mode, etc.

The system will adjust the presentation of messages to suit the mode of travel selected by the user and the GPS calculated speed. For example, when walking slowly around a town the user will be given more detail than when driving through the town or flying overhead.

Application Specific Modes

Certain applications may require a special mode of operation to focus the users attention on certain data, for example:

Walking Tours in Open Country

A map provides only limited information, whereas by using a walks database GPS Explorer can provide orientation, directional guidance and can identify landmarks by name. It can also keep the casual walker entertained with a poem or music or a description of the view at the appropriate point on the walk. A group may share the audio with personal radio earpieces without the need for wire connection or noise pollution from a loudspeaker.

The system will orientate the user by compass bearing or turn left/right command enabling the user to be directed to a pathway or to safety. By pointing the device at a hill for example the system will retrieve the name of the hill, it's height and any hazards such as cliffs.

With a database of walks, giving distances and times the system will calculate from the present GPS position and time if the number of hours of daytime left are sufficient for the selected walk to be completed safely.

In an emergency, a distress call can be made via cellular or satellite phone, incorporating GPS position data into the audio message to aid rescue services.

General Aviation Application.

Having selected general aviation mode for example, the system will identify the users GPS position, altitude and speed in relation to aviation related points such as airports, restricted areas, danger areas, light aircraft routes, air traffic control boundaries and so forth. The device will then provide the pilot with audio guidance, airspace alerting or an information retrieval by voice command, accepting pilot response by voice command or in noisy cockpits by press button.

Call Ahead

To find a telephone number when on the move can be difficult. This system provides several facilities which will help. In any mode the user has access to an audible facilities menu, providing a list of hotels, airlines and so on. When a selection has been made by the user, the system will automatically dial the telephone call using the telephone number held in the database.

The system uses GPS position, direction of travel and the user's pre-determined preferences to order the possible alternatives into a logical sequence for presentation to the user. For example, if the user is heading South at high speed by road, prefers a 4 star hotel and payment by AMEX the alternatives will be reduced. They will then be ranked in distance from present position. The system will then retrieve the correct telephone number ready for the user to request auto-dial telephone call for room reservation.

The system will also hold the users preferred credit card details on file avoiding any need to retrieve the card from a pocket while driving or flying. On the telephone, the user needs only to say “my AMEX number is” and the system will retrieve the card number data and finish the sentence for the user eg “1234 3456 567 expiry date 0695”.

En route advertising could also be inserted into tours at specified points to provide the user with the facility to call ahead to reserve a table for dinner, order flowers, to book a hotel room or reserve a ferry space.

Audio Commands

The device may be controlled by audio commands, chosen by the user, to perform a range of basic information storage and retrieval functions. The user will need to select commands which he/she is comfortable with. Examples of these are given below:

Menu—plays the main menu

OK—selects the last option stated

Repeat—replays the last audio phrase

X Mode—selects a specific mode

Stop—stops the audio

Start—starts the audio

Earpiece—switches to earpiece

Speaker—switches to loudspeaker

Skip—skips the present audio phrase

Position—gives position from . . .

Distance—gives distance from start, to . . .

Log on—starts a log of position data

Log off—stops log

2. An audio visual version of the design will now be described by reference to the following drawing:

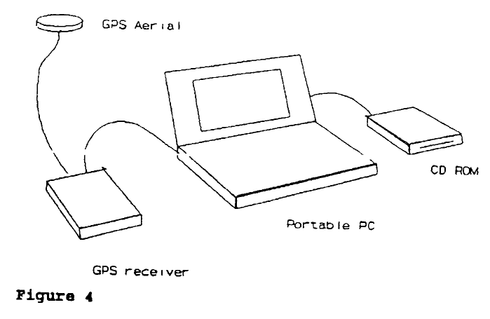

FIG. 4. Shows a version of the audio/visual system based on a standard portable PC. Still and/or motion video sequences will be stored on GPS-CD along with the GPS co-ordinates described in the audio example above. This visual data can then be accessed in several modes:

Pre-View Mode:

Before visiting a remote location, the user may use the device to pre-view the various places he intends to visit. Any visual sequences may be retrieved and played simply by entering the name or lat/long of the desired place or by selecting it from a list given by the system.

More Detail Mode:

In an audio mode, once audio details of a venue have been given by the system the user will be notified by a bleep or prompt if pictorial information is also available from the database. The user may then select it if required.

Simulation Mode:

Having arrived at a physical location or identified it in pre-view mode, the user may access the database to obtain a computer based simulation of some aspect of the location. For example to see the route of a proposed new road or the simulated facade of a proposed new building. By walking around the physical site, as the GPS data changes so will the simulation to illustrate the simulated views from the new physical position taking into consideration the users orientation, height, direction of view, view angle of azimuth and time of day. The simulation may be presented on a display screen or any form of image projection system such as a virtual reality helmet or other device. If used in conjunction with a head up display the user will have both the present image and simulated future in view simultaneously enabling comparison.

3. A real time version of the device will now be described.

To enable the user to have access to up to the minute information the device incorporates a radio or television receiver to receive specially broadcast regional data transmissions. The system selects incoming data relevant to the chosen mode of use and location based on GPS calculated position. Selected data items are stored in memory in the device on receipt and then handled in the same way as other database data described earlier.

The real time data system could provide the user with access to and automatically search a wide range of information sources: local weather, weather reports for pilots and yachtsmen, scheduled flight delays, details of special events, hotel room availability, road conditions, audio guided diversions, financial market updates for example.

4. A virtual reality version of the device will now be described.

Virtual reality is a term used to describe a computer generated three dimensional image which when observed using a special form of projection system or helmet, creates the illusion of reality and allows the user to move through it and to react with computer generated objects.

This invention combines the real world image with computer generated images. The device obtains it's real world frame of reference from it's GPS position. This allows the device to generate virtual objects so they are correctly located within the observers real world. The resulting computer generated image may then be projected into the users field of view using split image spectacles. Alternatively the computer generated objects may be overlaid on a video picture of the real world and the resulting composite image projected for an observer wearing an artificial reality helmet.

The device enables a fire or rescue crew visiting say an oil rig to superimpose structural, electrical or hazard data onto their real world view of the structure, giving them safety related information and audible hazard alerts.

The device would also enable a user visiting the site for a new building to see the computer generated image of the new building superimposed in the landscape. The computer generated image will change as the user's GPS position changes when he walks around the site.

### Commercial Exploitation of the Invention

Revenue can be generated from sales of the GPS Explorer units, application CD's and real time services.

Sales of GPS Explorer CD's are expected to provide the greatest growth potential as the range of potential applications for the system is almost unlimited. Each new application will require companies around the world to produce new CD's for their market. Many Explorer CD's will incorporate details of the businesses in an area, rather like an interactive version of Yellow Pages. But unlike Yellow Pages who leave customers with the problem of finding the advertisers premises, the GPS Explorer system leads the customer to the advertiser, even it their premises are difficult to find, it will even dial the number automatically to enable the user to check requirements before going there.

1. A device which uses GPS data to select audio phrases from a database or radio broadcast.

2. A device as in claim 1 which is provided with a still or motion picture system in which the pictures are retrieved either from a database or radio or television broadcast data.

3. A device as in claim 1 or 2 which is provided with a menu system which uses the human voice or a display screen to describe options.

4. A device as in claims 1-3 which is controlled by spoken audio command or by keyboard or by any form of joystick or switch.

5. A device as in claims 1-4 which is provided with a radio or radio interface to receive broadcast audio or broadcast data.

6. A device as in claims 1-5 which is provided with a telephone or telephone interface such that a telephone call can be made using telephone numbers from the database or broadcast, without the need to dial the number.

7. A device as in claims 1-6 which is provided with a an optical, magnetic, radio or other device capable of inputting data for the purpose of identifying location, products, persons, vehicles, systems, temperatures or any environmental variables.

8. A device as in claims 1-7 incorporating systems for determining user orientation including:
direction of movement, heading, rate of climb or descent, pitch angle and rate, roll angle and rate. This system will also determine direction of view as compass bearing, azimuth and range.

9. A device as in claims 1-8 with the facility to present the user with a visible and/or audible simulation of an alternative three dimensional environment based on his position and orientation and direction of view in the real world as determined by GPS.

10. A device as in claims 1-9 with more than one channel for simultaneous use by a group of users.

11. A device embodying any combination of the features described in claims 1-10.
